SEQUENCE LISTING (1 sequence)

SEQ ID NO: 1 - protein, 471 aa, Geobacillus stearothermophilus
MTKLIKNGTIVTATDIYEADLLIQDGKIAVIGRNLDESGAEVIDATGCYVFPGGIDPHTHLDMPFGGTVTKDDFESGTIAAAFGGTTTIIDFCLTNKGEPLKKAIETWHNKATGKAVIDYGFHLMISEITDDVLEELPKVIEEEGITSFKVFMAYKDVFQADDGTLYRTLVAAKELGALVMVHAENGDVIDYLTKKALEDGHTDPIYHALTRPPELEGEATGRACQLTELAGSQLYVVHVSCAQAVEKIAEARNKGLNVWGETCPQYLVLDQSYLEKPNFEGAKYVWSPPLREKWHQEVLWNALKNGQLQTLGSDQCSFDFKGQKELGRGDFTKIPNGGPIIEDRVSILFSEGVKKGRITLNQFVDIVSTRIAKLFGLFPKKGTIAVGADADLVIFDPTVERVISAETHHMAVDYNPFEGMKVTGEPVSVLCRGEFVVRDKQFVGKPGYGQYVKRAKYGALMADQDVVKMS

(19) United States
(12) Patent Application Publication
(10) Pub. No.: US 2025/0049037 A1
(43) Pub. Date: Feb. 13, 2025

(54) HERBICIDAL ACTIVITY OF ALKYL PHOSPHINATES

(71) Applicant: BASF SE, Ludwigshafen (DE)

(72) Inventors: Klaus Ditrich, Goennheim (DE); Michael Breuer, Ludwigshafen (DE); Moritz Stefan Pott, Ludwigshafen (DE); Gunther Zimmermann, Ludwigshafen (DE)

(21) Appl. No.: 18/717,747

(22) PCT Filed: Dec. 12, 2022
(86) PCT No.: PCT/EP2022/085312

§ 371 Date: Jun. 7, 2024

(30) Foreign Application Priority Data
Dec. 10, 2021 (EP) 21213751.7

(51) Int. Cl. A01N 57/20; A01N 57/24; A01P 13/02; C07F 9/32

(52) U.S. Cl. CPC A01N 57/20; A01N 57/24; A01P 13/02; C07F 9/3211

(57) ABSTRACT

The present invention relates to compounds of formula (I) and compositions comprising the same. The invention also relates to the use of compounds of formula (I), or of compositions comprising the same, or of compounds of formula (II), for controlling unwanted vegetation. Further, the invention relates to methods of applying compounds of formula (I), or compositions comprising the same, or compounds of formula (II) on plants, their seed and/or their habitat. Finally, the invention relates to a method of manufacturing a compound of formula (III) via a compound of formula (I).

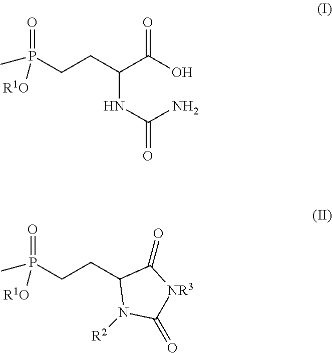

The present invention relates to compounds of formula (I) and compositions comprising the same. The invention also relates to the use of compounds of formula (I), or of compositions comprising the same, or of compounds of formula (II), for controlling unwanted vegetation. Further, the invention relates to methods of applying compounds of formula (I), or compositions comprising the same, or compounds of formula (II) on plants, their seed and/or their habitat. Finally, the invention relates to a method of manufacturing a compound of formula (III) via a compound of formula (I).

For the purpose of controlling unwanted vegetation, especially in crops, there is an ongoing need for new active herbicides.

It is known that hydantoins as depicted in Scheme 1 can be intermediates in the synthesis of racemic glufosinate (also known as phosphinothricin or (S)-2-amino-4-(hydroxy(methyl) phosphonoyl)butanoic acid). They may be accessed from the respective aldehydes (Scheme 1) by the Bucherer-Bergs Reaction. A further synthesis route is e.g. described in CN 111662325. However, the herbicidal activity has not been investigated, yet.

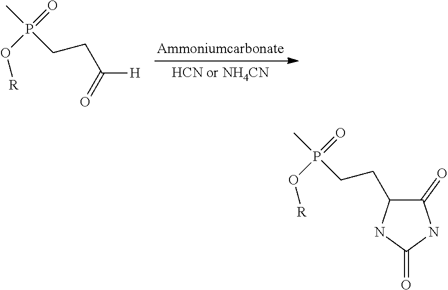

### Scheme 1. Syntheses of Hydantoin Via the Respective Aldehyde (Wherein R is e.g. H or Alkyl)

Against the above background, it has been an object of the present invention to provide new compounds having herbicidal activity.

It has further been an object of the present invention to find compounds for controlling unwanted vegetation.

It has further been an object of the present invention to provide a method for selectively controlling weeds.

It has further been an object of the present invention to provide a new synthetic access of glufosinate.

It has surprisingly been found by the inventors of the present invention that at least one of the above objects can be obtained by the herein described compounds. It has further been found by the inventors of the present invention that the claimed method provides a composition for using as herbicide.

In a first aspect, the present invention therefore relates to a compound of formula (I)

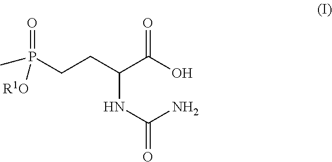

wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl;
including its agriculturally acceptable salts, amides, esters or thioesters.

In the following, preferred embodiments of the substituents of the compound of formula (I), the composition, the use of a compound of formula (II), the method of selectively controlling weeds are described in further detail, and the method of manufacturing a compound of formula (III) via a compound of formula (I). It is to be understood that each preferred embodiment is relevant on its own as well as in combination with other preferred embodiments.

In a preferred embodiment A1 of the first aspect, R¹ is hydrogen, (C₁-C₈)-alkyl, or (C₁-C₈)-haloalkyl, preferably hydrogen, (C₁-C₆)-alkyl, or (C₁-C₆)-haloalkyl, more preferably hydrogen, (C₂-C₄)-alkyl, or (C₂-C₄)-haloalkyl, and in particular hydrogen, ethyl, or butyl.

In a preferred embodiment A2 of the first aspect, formula (I) is the stereoisomer having formula (Ia)

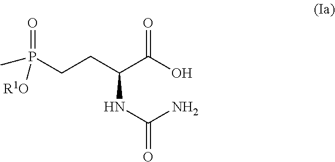

or having formula (Ib)

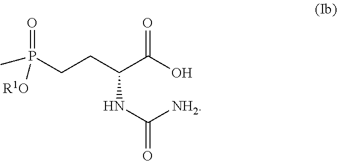

In a second aspect, the present invention relates to a composition comprising at least one compound according to the first aspect and at least one auxiliary, which is customary for formulating crop protection compounds.

In a preferred embodiment B1 of the second aspect, the composition further comprises a compound of formula (II)

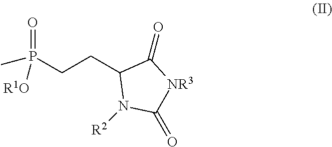

wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl, preferably hydrogen, (C₁-C₆)-alkyl, or (C₁-C₆)-haloalkyl, more preferably hydrogen, (C₂-C₄)-alkyl, or (C₂-C₄)-haloalkyl, and in particular hydrogen, ethyl, or butyl;
R² is hydrogen, (C₁-C₃)-alkyl, or (C₁-C₃)-haloalkyl, preferably hydrogen or (C₁-C₃)-alkyl, more preferably hydrogen or methyl, and in particular hydrogen; and
R³ is hydrogen, (C₁-C₃)-alkyl, or (C₁-C₃)-haloalkyl, preferably hydrogen or (C₁-C₃)-alkyl, more preferably hydrogen or methyl, and in particular hydrogen; including its agriculturally acceptable salts.

In a preferred embodiment B2 of the second aspect, the composition comprises a further herbicide.

In a third aspect, the present invention relates to the use of a compound of formula (II)

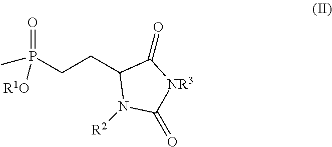

wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl;
R² is hydrogen, (C₁-C₃)-alkyl, or (C₁-C₃)-haloalkyl; and
R³ is hydrogen, (C₁-C₃)-alkyl, or (C₁-C₃)-haloalkyl;
including its agriculturally acceptable salts,
or a compound according to the first aspect, or a composition according to the second aspect, for controlling unwanted vegetation.

In a preferred embodiment C1 of the third aspect, the substituents of the compound of formula (II) are further specified as follows:
R¹ is hydrogen, (C₁-C₆)-alkyl, or (C₁-C₆)-haloalkyl, preferably hydrogen, (C₂-C₄)-alkyl, or (C₂-C₄)-haloalkyl, and in particular hydrogen, ethyl, or butyl;
R² is hydrogen or (C₁-C₃)-alkyl, preferably hydrogen or methyl, and in particular hydrogen; and R³ is hydrogen or (C₁-C₃)-alkyl, preferably hydrogen or methyl, and in particular hydrogen.

In a preferred embodiment C2 of the third aspect, the formula (II) is the stereoisomer having formula (IIa)

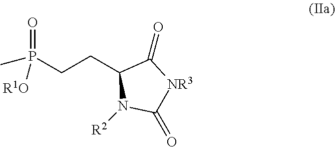

or formula (IIb)

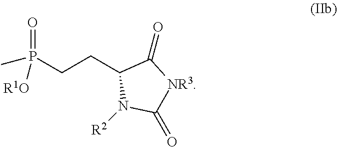

In a preferred embodiment C3 of the third aspect, the unwanted vegetation is selected from the group consisting of Alopecurus myosuroides (ALOMY), Avena fatua (AVEFA), Echinochloa crus-galli (ECHCG), Setaria viridis (SETVI), Abutilon theophrasti (ABUTH), Amaranthus retroflexus (AMARE), Apera spica-venti (APESV), Setaria faberi (SETFA), and mixtures thereof, preferably selected from the group consisting of Amaranthus retroflexus (AMARE), Echinochloa crus-galli (ECHCG), Apera spica-venti (APESV), and mixtures thereof or consisting of Amaranthus retroflexus (AMARE), Setaria viridis (SETVI), Abutilon theophrasti (ABUTH), Setaria faberi (SETFA), and mixtures thereof.

In a preferred embodiment C4 of the third aspect, the substituent of the compound of formula (Ib) is further specified as follows:
R¹ is hydrogen, (C₁-C₈)-alkyl or (C₁-C₈)-haloalkyl, preferably hydrogen, (C₁-C₆)-alkyl or (C₁-C₆)-haloalkyl, more preferably hydrogen, (C₂-C₄)-alkyl, or (C₂-C₄)-haloalkyl, and in particular hydrogen, ethyl, or butyl, and the unwanted vegetation is selected from the group consisting of Amaranthus retroflexus (AMARE), Echinochloa crus-galli (ECHCG), Apera spica-venti (APESV), Setaria faberi (SETFA), and mixtures thereof.

In a preferred embodiment C5 of the third aspect, the substituents of the compound of formula (II) are further specified as follows:
R¹ is hydrogen;
R² is hydrogen or methyl; and
R³ is hydrogen or methyl, and the unwanted vegetation is selected from the group consisting of Amaranthus retroflexus (AMARE), Setaria viridis (SETVI), Abutilon theophrasti (ABUTH), and mixtures thereof.

In a fourth aspect, the present invention relates to a method for controlling unwanted vegetation which comprises allowing a herbicidally effective amount of at least one compound of formula (II)

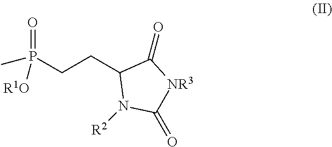

wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl;
R² is hydrogen, (C₁-C₃)-alkyl, or (C₁-C₃)-haloalkyl; and
R³ is hydrogen, (C₁-C₃)-alkyl, or (C₁-C₃)-haloalkyl;
including its agriculturally acceptable salts, or a compound according to the first aspect, or a composition according to the second aspect to act on plants, their seed and/or their habitat.

In a preferred embodiment D1 of the fourth aspect, the unwanted vegetation is selected from the group consisting of Alopecurus myosuroides (ALOMY), Avena fatua (AVEFA), Echinochloa crus-galli (ECHCG), Setaria viridis (SETVI), Abutilon theophrasti (ABUTH), Amaranthus retroflexus (AMARE), Apera spica-venti (APESV), Setaria faberi (SETFA), and mixtures thereof.

In a fifth aspect, the present invention relates to a method of manufacturing glufosinate, its alkyl ester or the salts thereof having the formula (III)

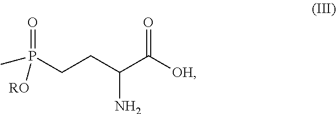

wherein R is hydrogen, (C₁-C₈)-alkyl, (C₁-C₈)-haloalkyl, (C₂-C₈)-alkenyl, (C₂-C₈)-haloalkenyl, or (C₂-C₈)-alkynyl, comprising the step of chemically cleaving off the carbamoyl moiety of a compound of formula (I)

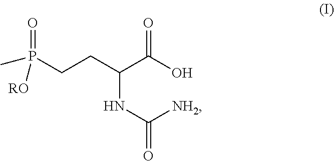

wherein R is hydrogen, (C₁-C₈)-alkyl, (C₁-C₈)-haloalkyl, (C₂-C₈)-alkenyl, (C₂-C₈)-haloalkenyl, or (C₂-C₈)-alkynyl.

### DETAILED DESCRIPTION

Before describing in detail exemplary embodiments of the present invention, definitions important for understanding the present invention are given.

As used in this specification and in the appended claims, the singular forms of “a” and “an” also include the respective plurals unless the context clearly dictates otherwise. In the context of the present invention, the terms “about” and “approximately” denote an interval of accuracy that a person skilled in the art will understand to still ensure the technical effect of the feature in question. The term typically indicates a deviation from the indicated numerical value of ±15%, preferably ±10%, even more preferably ±5%, and even more preferably ±2%. It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(a)”, “(b)”, “(c)”, “(d)”, “i”, “ii” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below. It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

The term “wt.-%” as used throughout herein stands for “percent by weight”.

Within the meaning of the present invention, the term formulation and compositions denote the same.

The prefix Cₓ-C_{y} denotes the number of possible carbon atoms in the particular case. All hydrocarbon chains can be straight-chain or branched.

The term “alkyl” as used herein denotes in each case a straight-chain or branched alkyl group having usually from 1 to 8 carbon atoms, preferably from 1 to 6 carbon atoms, frequently from 1 to 5 carbon atoms, more preferably 1 to 4 carbon atoms, e.g. 2 or 4 carbon atoms. Examples of alkyl groups are methyl, ethyl, n-propyl, iso-propyl, n-butyl, 2-butyl, iso-butyl, tert-butyl, n-pentyl, 1-methylbutyl, 2-methylbutyl, 3-methylbutyl, 2,2-dimethylpropyl, 1-ethylpropyl, and n-hexyl.

The term “haloalkyl” as used herein denotes in each case a straight-chain or branched alkyl group having usually from 1 to 8 carbon atoms, preferably from 1 to 6 carbon atoms, especially 2 or 4 carbon atoms, wherein the hydrogen atoms of this group are partially or totally replaced with halogen atoms. Preferred haloalkyl moieties are selected from C₁-C₄-haloalkyl such as C₁-C₂-fluoroalkyl such as fluoromethyl, difluoromethyl, trifluoromethyl, 1-fluoroethyl, 2-fluoroethyl, 2,2-difluoroethyl, 2,2,2-trifluoroethyl, pentafluoroethyl, and the like.

The term “alkenyl” as used herein denotes in each case an at least singly unsaturated hydrocarbon radical, i.e. a hydrocarbon radical having at least one carbon-carbon double bond, having usually 2 to 8 carbon atoms, preferably 2 to 4 carbon atoms, e.g. vinyl, allyl (2-propen-1-yl), 1-propen-1-yl, 2 propen-2-yl, methallyl (2-methylprop-2-en-1-yl), 2-buten-1-yl, 3-buten-1-yl, 2-penten-1-yl, 3-penten-1-yl, 4-penten-1-yl, 1-methylbut-2-en-1-yl, 2-ethylprop-2-en-1-yl and the like.

The term “haloalkenyl” as used herein denotes in each case a straight-chain or branched alkenyl group having usually from 1 to 8 carbon atoms, preferably from 1 to 6 carbon atoms, especially 2 or 4 carbon atoms, wherein the hydrogen atoms of this group are partially or totally replaced with halogen atoms.

The term “alkynyl” as used herein denotes in each case a hydrocarbon radical having at least one carbon-carbon triple bond and having usually 2 to 8, preferably 2 or 3 carbon atoms or 3 or 4 carbon atoms, e.g. ethynyl, propargyl (2-propyn-1-yl, also referred to as prop-2-yn-1-yl), 1-propyn-1-yl (also referred to as prop-1-yn-1-yl), 1-methylprop-2-yn-1-yl, 2-butyn-1-yl, 3-butyn-1-yl, 1-pentyn-1-yl, 3-pentyn-1-yl, 4-pentyn-1-yl, 1-methylbut-2-yn-1-yl, 1-ethylprop-2-yn-1-yl and the like. A preferred alkynyl group according to the invention is propargyl.

Depending on the substitution pattern, the compounds according to the invention may have one or more stereocenters. Unless explicitly indicated otherwise (e.g. via a chemical formula) and the invention preferably encompasses all stereoisomers, i.e. pure enantiomers, pure diastereomers, of the compounds according to the invention, and their mixtures, including racemic mixtures.

If the compounds of formula (I) and (II) as described herein have ionizable functional groups, they can also be employed in the form of their agriculturally acceptable salts. Suitable are, in general, the salts of those cations and the acid addition salts of those acids whose cations and anions, respectively, have no adverse effect on the activity of the active compounds.

Preferred cations are the ions of the alkali metals, preferably of lithium, sodium and potassium, of the alkaline earth metals, preferably of calcium and magnesium, and of the transition metals, preferably of manganese, copper, zinc and iron, further ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diethylammonium, diisopropylammonium, trimethylammonium, triethylammonium, tris(isopropyl)ammonium, heptylammonium, dodecylammonium, tetradecylammonium, tetramethylammonium, tetraethylammonium, tetrabutylammonium, 2-hydroxyethylammonium (olamine salt), 2-(2-hydroxyeth-1-oxy)eth-1-ylammonium (diglycolamine salt), di(2-hydroxyeth-1-yl)ammonium (diolamine salt), tris(2-hydroxyethyl)ammonium (trolamine salt), tris(2-hydroxypropyl)ammonium, benzyltrimethylammonium, benzyltriethylammonium, N,N,N-trimethylethanolammonium (choline salt), furthermore phosphonium ions, sulfonium ions, preferably tri(C₁-C₄-alkyl)sulfonium, such as trimethylsulfonium, and sulfoxonium ions, preferably tri(C₁-C₄-alkyl)sulfoxonium, and finally the salts of polybasic amines such as N,N-bis-(3-aminopropyl)methylamine and diethylenetriamine.

Anions of useful acid addition salts are primarily chloride, bromide, fluoride, iodide, hydrogensulfate, methylsulfate, sulfate, dihydrogenphosphate, hydrogenphosphate, nitrate, bicarbonate, carbonate, hexafluorosilicate, hexafluorophosphate, benzoate and also the anions of C₁-C₄-alkanoic acids, preferably formate, acetate, propionate and butyrate.

Compounds of formula (I), as described herein having a carboxyl group can be employed in the form of the acid, in the form of an agriculturally suitable salt as mentioned above or else in the form of an agriculturally acceptable derivative, for example as amides, such as mono- and di-C₁-C₆-alkylamides or arylamides, as esters, for example as allyl esters, propargyl esters, C₁-C₁₀-alkyl esters, alkoxyalkyl esters, tefuryl ((tetrahydrofuran-2-yl)methyl) esters and also as thioesters, for example as C₁-C₁₀-alkylthio esters. Preferred mono- and di-C₁-C₆-alkylamides are the methyl and the dimethylamides. Preferred arylamides are, for example, the anilides and the 2-chloroanilides. Preferred alkyl esters are, for example, the methyl, ethyl, propyl, isopropyl, butyl, isobutyl, pentyl, mexyl (1-methylhexyl), meptyl (1-methylheptyl), heptyl, octyl or isooctyl (2-ethylhexyl) esters. Preferred C₁-C₄-alkoxy-C₁-C₄-alkyl esters are the straight-chain or branched C₁-C₄-alkoxy ethyl esters, for example the 2-methoxyethyl, 2-ethoxyethyl, 2-butoxyethyl (butotyl), 2-butoxypropyl or 3-butoxypropyl ester. An example of a straight-chain or branched C₁-C₁₀-alkylthio ester is the ethylthio ester.

As indicated above, the present invention relates in one aspect to compound of formula (I)

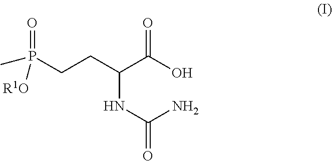

wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl;
including its agriculturally acceptable salts, amides, esters or thioesters.

It is to be understood that the compound of formula (I) encompasses all stereoisomers, agriculturally acceptable salts, amides, esters or thioesters. Further, the respective zwitterions are encompassed by the formula (I). In this connection, the compound of formula (I) in particular encompasses two stereocenters, wherein one stereocenter is located at the phosphor atom and one stereocenter is located at the alpha carbon atom. The compound of formula (I) in particular encompasses all stereoisomers derived from the stereocenter at the phosphor atom.

Preferred embodiment regarding the compounds of formula (I), the compositions comprising the same, the use of said compounds, of said compositions, and of compounds of formula (II) for controlling unwanted vegetation, and the method of selectively controlling weeds, are described in detail hereinafter. It is to be understood that the preferred embodiments of the invention are preferred alone or in combination with each other.

In a preferred embodiment, R¹ in the compound of formula (I) is hydrogen, (C₁-C₈)-alkyl, or (C₁-C₈)-haloalkyl, preferably hydrogen, (C₁-C₆)-alkyl, or (C₁-C₆)-haloalkyl, more preferably hydrogen, (C₂-C₄)-alkyl, or (C₂-C₄)-haloalkyl, and in particular hydrogen, ethyl, or butyl.

In a preferred embodiment, the compound of formula (I) is the stereoisomer having formula (Ia)

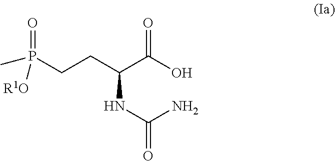

or having formula (Ib)

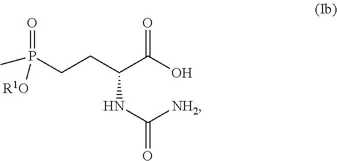

wherein R¹ is preferably hydrogen, (C₁-C₈)-alkyl, or (C₁-C₈)-haloalkyl, more preferably hydrogen, (C₁-C₆)-alkyl, or (C₁-C₆)-haloalkyl, even more preferably hydrogen, (C₂-C₄)-alkyl, or (C₂-C₄)-haloalkyl, and in particular hydrogen, ethyl, or butyl.

It is particularly preferred that the compound of formula (I) is the stereoisomer having formula (Ib), wherein R¹ is preferably hydrogen, (C₁-C₈)-alkyl, or (C₁-C₈)-haloalkyl, more preferably hydrogen, (C₁-C₆)-alkyl, or (C₁-C₆)-haloalkyl, even more preferably hydrogen, (C₂-C₄)-alkyl, or (C₂-C₄)-haloalkyl, and in particular hydrogen or butyl.

The compound of formula (I) is exemplarily accessible by treating the respective hydantoin with a Hydantoinase enzyme. In this connection, Hydantoinase enzyme A0A159Z531_9RHOB may be named.

The compounds of formula (I), are suitable as herbicides. They are suitable as such, as an appropriate composition or in combination with further herbicides.

As indicated above, the present invention further relates in a second aspect to a composition comprising at least one compound of formula (I)

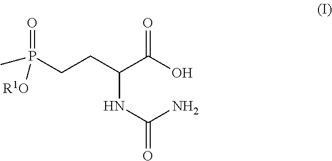

wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl;
including its agriculturally acceptable salts, amides, esters or thioesters and at least one auxiliary, which is customary for formulating crop protection compounds.

Preferred embodiment of the compound of formula (I) are already described above in further detail and apply for the second aspect, as well.

In a preferred embodiment, the composition further comprises a compound of formula (II)

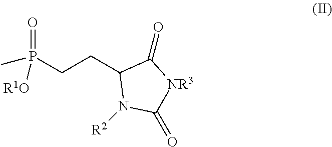

wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl, preferably hydrogen, (C₁-C₆)-alkyl, or (C₁-C₆)-haloalkyl, more preferably hydrogen, (C₂-C₄)-alkyl, or (C₂-C₄)-haloalkyl, and in particular hydrogen, ethyl, or butyl;
R² is hydrogen, (C₁-C₃)-alkyl, or (C₁-C₃)-haloalkyl, preferably hydrogen or (C₁-C₃)-alkyl, more preferably hydrogen or methyl, and in particular hydrogen; and
R³ is hydrogen, (C₁-C₃)-alkyl, or (C₁-C₃)-haloalkyl, preferably hydrogen or (C₁-C₃)-alkyl, more preferably hydrogen or methyl, and in particular hydrogen; including its agriculturally acceptable salts.

The compound of formula (II) may exemplarily be synthesized according to CN 111662325.

In a preferred embodiment, the composition comprises a further herbicide. Suitable further herbicides may be selected from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

In a preferred embodiment, the further herbicide is a glutamine synthase inhibitor, preferably selected from the group consisting of bilanaphos (bialaphos), bilanaphos-sodium, glufosinate, glufosinate-P and glufosinate-ammonium.

It may furthermore be beneficial that the composition comprises additional crop protection agents, for example for controlling pests or phytopathogenic fungi or bacteria. Also of interest is the miscibility with mineral salt solutions, which are employed for treating nutritional and trace element deficiencies. Other additives such as non-phytotoxic oils and oil concentrates may also be added.

Preferably, the composition comprises a herbicidally effective amount of a compound of formula (I) and optionally of a compound of formula (II). The term “herbicidally effective amount” denotes an amount of the compound of formula (I) and optionally of a compound of formula (II), which is sufficient for controlling undesired vegetation, especially for controlling undesired vegetation in crops (i.e. cultivated plants) and which does not result in a substantial damage to the treated crop plants. Such an amount can vary in a broad range and is dependent on various factors, such as the undesired vegetation to be controlled, the treated crop plants or material, the climatic conditions and the specific compound of formula (I) and optionally of a compound of formula (II) used.

The compounds of formula (I), their salts, amides, esters or thioesters can be converted into customary types of formulations, e. g. solutions, emulsions, suspensions, dusts, powders, pastes, granules, pressings, capsules, and mixtures thereof. Examples for formulation types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further formulation types are defined in the “Catalogue of pesticide formulation types and international coding system”, Technical Monograph No. 2, 6^{th} Ed. May 2008, CropLife International.

The formulations are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetting agents, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide.

Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compounds of formula (I) on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), inorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

The compositions may comprise auxiliaries, such as 0.1-1 wt.-% bactericides, 5-15 wt.-% anti-freezing agents, 0.1-1 wt.-% anti-foaming agents, and 0.1-1 wt.-% colorants.

Examples for formulation types and their preparation are:

### i) Water-Soluble Concentrates (SL, LS)

10-60 wt.-% of a compound of formula (I) or a combination comprising at least one compound of formula (I) and at least one compound of formula (II) according to the invention and 5-15 wt % wetting agent (e.g. alcohol alkoxylates) are dissolved in water and/or in a water-soluble solvent (e.g. alcohols) ad 100 wt.-%. The active substance dissolves upon dilution with water.

### ii) Dispersible Concentrates (DC)

5-25 wt.-% of a compound of formula (I) or a combination comprising at least one compound of formula (I) and at least one compound of formula (II) according to the invention and 1-10 wt.-% dispersant (e. g. polyvinylpyrrolidone) are dissolved in organic solvent (e.g. cyclohexanone) ad 100 wt.-%. Dilution with water gives a dispersion.

iii) Emulsifiable Concentrates (EC)

15-70 wt.-% of compound of formula (I) or a combination comprising at least one compound of formula (I) and at least one compound of formula (II) according to the invention and 5-10 wt.-% emulsifiers (e.g. calcium dodecylbenzenesulfonate and castor oil ethoxylate) are dissolved in water-insoluble organic solvent (e.g. aromatic hydrocarbon) ad 100 wt.-%. Dilution with water gives an emulsion.

### iv) Emulsions (EW, EO, ES)

5-40 wt.-% of compound of formula (I) or a combination comprising at least one compound of formula (I) and at least one compound of formula (II) according to the invention and 1-10 wt.-% emulsifiers (e.g. calcium dodecylbenzenesulfonate and castor oil ethoxylate) are dissolved in 20-40 wt.-% water-insoluble organic solvent (e.g. aromatic hydrocarbon). This mixture is introduced into water ad 100 wt.-% by means of an emulsifying machine and made into a homogeneous emulsion. Dilution with water gives an emulsion.

### v) Suspensions (SC, OD, FS)

In an agitated ball mill, 20-60 wt.-% of a compound of formula (I) or a combination comprising at least one compound of formula (I) and at least one compound of formula (II) according to the invention are comminuted with addition of 2-10 wt.-% dispersants and wetting agents (e.g. sodium lignosulfonate and alcohol ethoxylate), 0.1-2 wt.-% thickener (e.g. xanthan gum) and water ad 100 wt.-% to give a fine active substance suspension. Dilution with water gives a stable suspension of the active substance. For FS type formulation up to 40 wt.-% binder (e.g. polyvinylalcohol) is added.

### vi) Water-Dispersible Granules and Water-Soluble Granules (WG, SG)

50-80 wt.-% of a compound of formula (I) or a combination comprising at least one compound of formula (I) and at least one compound of formula (II) according to the invention are ground finely with addition of dispersants and wetting agents (e.g. sodium lignosulfonate and alcohol ethoxylate) ad 100 wt.-% and prepared as water-dispersible or water-soluble granules by means of technical appliances (e. g. extrusion, spray tower, fluidized bed). Dilution with water gives a stable dispersion or solution of the active substance.

vii) Water-Dispersible Powders and Water-Soluble Powders (WP, SP, WS)

50-80 wt.-% of a compound of formula (I) or a combination comprising at least one compound of formula (I) and at least one compound of formula (II) according to the invention are ground in a rotor-stator mill with addition of 1-5 wt.-% dispersants (e.g. sodium lignosulfonate), 1-3 wt.-% wetting agents (e.g. alcohol ethoxylate) and solid carrier (e.g. silica gel) ad 100 wt.-%. Dilution with water gives a stable dispersion or solution of the active substance.

viii) Gel (GW, GF)

In an agitated ball mill, 5-25 wt.-% of a compound of formula (I) or a combination comprising at least one compound of formula (I) and at least one compound of formula (II) according to the invention are comminuted with addition of 3-10 wt.-% dispersants (e.g. sodium lignosulfonate), 1-5 wt.-% thickener (e.g. carboxymethylcellulose) and water ad 100 wt.-% to give a fine suspension of the active substance. Dilution with water gives a stable suspension of the active substance.

### iv) Microemulsion (ME)

5-20 wt.-% of a compound of formula (I) or a combination comprising at least one compound of formula (I) and at least one compound of formula (II) according to the invention are added to 5-30 wt % organic solvent blend (e.g. fatty acid dimethylamide and cyclohexanone), 10-25 wt.-% surfactant blend (e.g. alcohol ethoxylate and arylphenol ethoxylate), and water ad 100 wt.-%.

This mixture is stirred for 1 h to produce spontaneously a thermodynamically stable microemulsion.

### iv) Microcapsules (CS)

An oil phase comprising 5-50 wt.-% of a compound of formula (I) or a combination comprising at least one compound of formula (I) and at least one compound of formula (II) according to the invention, 0-40 wt.-% water insoluble organic solvent (e.g. aromatic hydrocarbon), 2-15 wt.-% acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt.-% of a compound of formula (I) or a combination comprising at least one compound of formula (I) and at least one compound of formula (II) according to the invention, 0-40 wt.-% water insoluble organic solvent (e.g. aromatic hydrocarbon), and an isocyanate monomer (e.g. diphenylmethene-4,4′-diisocyanate) are dispersed into an aqueous solution of a protective colloid (e.g. polyvinyl alcohol). The addition of a polyamine (e.g. hexamethylenediamine) results in the formation of polyurea microcapsules. The monomers amount to 1-10 wt.-%. The wt.-% relate to the total CS formulation.

### ix) Dustable Powders (DP, DS)

1-10 wt.-% of a compound of formula (I) or a combination comprising at least one compound of formula (I) and at least one compound of formula (II) according to the invention are ground finely and mixed intimately with solid carrier (e.g. finely divided kaolin) ad 100 wt.-%.

### x) Granules (GR, FG)

0.5-30 wt.-% of a compound of formula (I) or a combination comprising at least one compound of formula (I) and at least one compound of formula (II) according to the invention is ground finely and associated with solid carrier (e.g. silicate) ad 100 wt.-%. Granulation is achieved by extrusion, spray-drying or the fluidized bed.

### xi) Ultra-Low Volume Liquids (UL)

1-50 wt.-% of a compound of formula (I) or a combination comprising at least one compound of formula (I) and at least one compound of formula (II) according to the invention are dissolved in organic solvent (e.g. aromatic hydrocarbon) ad 100 wt.-%.

The formulation types i) to xi) may optionally comprise further auxiliaries, such as 0.1-1 wt.-% bactericides, 5-15 wt.-% anti-freezing agents, 0.1-1 wt.-% anti-foaming agents, and 0.1-1 wt.-% colorants.

The composition preferably comprise between 0.01 and 95 wt.-%, more preferably between 0.1 and 90 wt.-%, and in particular between 0.5 and 75 wt.-% of the compound of formula (I) or of a combination of the compound of formulae (I) and (II), based on the total weight of the composition.

The compounds of formulae (I) and (II) are employed in a purity of from 90% to 100%, preferably from 95% to 100% (according to NMR spectrum).

Solutions for seed treatment (LS), suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The formulations in question give, after two-to-tenfold dilution, active substance concentrations of from 0.01 to 60% by weight, preferably from 0.1 to 40% by weight, in the ready-to-use preparations.

As mentioned above, the invention relates in a third aspect to the use of a compound of formula (II)

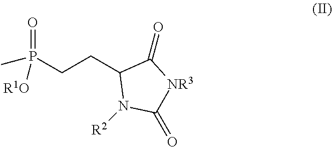

wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl;
R² is hydrogen, (C₁-C₃)-alkyl, or (C₁-C₃)-haloalkyl; and
R³ is hydrogen, (C₁-C₃)-alkyl, or (C₁-C₃)-haloalkyl;
including its agriculturally acceptable salts,
or a compound of formula (I)

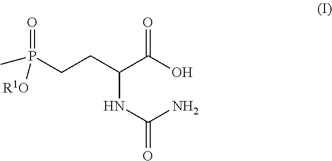

wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl;
including its agriculturally acceptable salts, amides, esters or thioesters, or a composition as above-outlined in more detail, for controlling unwanted vegetation.

It is to be understood that the respective zwitterion of the compound of formula (I) or the compound of formula (II) is also encompassed.

Preferred embodiment, regarding the compound of formula (I), the compound of formula (II) and the composition are already above-outlined and apply for the use, as well.

Further preferred embodiment are outlined in the following.

In a preferred embodiment, the substituents of the compound of formula (II) are further specified as follows:
R¹ is hydrogen, (C₁-C₆)-alkyl, or (C₁-C₆)-haloalkyl, preferably hydrogen, (C₂-C₄)-alkyl, or (C₂-C₄)-haloalkyl, and in particular hydrogen, ethyl, or butyl;
R² is hydrogen or (C₁-C₃)-alkyl, preferably hydrogen or methyl, and in particular hydrogen; and
R³ is hydrogen or (C₁-C₃)-alkyl, preferably hydrogen or methyl, and in particular hydrogen.

In a preferred embodiment, the formula (II) is the stereoisomer having formula (IIa)

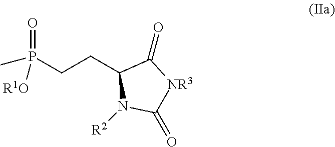

or formula (IIb)

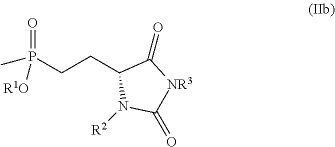

wherein preferably
R¹ is hydrogen, (C₁-C₆)-alkyl, or (C₁-C₆)-haloalkyl, preferably hydrogen, (C₂-C₄)-alkyl, or (C₂-C₄)-haloalkyl, and in particular hydrogen, ethyl, or butyl;
R² is hydrogen or (C₁-C₃)-alkyl, preferably hydrogen or methyl, and in particular hydrogen; and
R³ is hydrogen or (C₁-C₃)-alkyl, preferably hydrogen or methyl, and in particular hydrogen.

In a preferred embodiment, the unwanted vegetation is selected from the group consisting of Alopecurus myosuroides (ALOMY), Avena fatua (AVEFA), Echinochloa crus-galli (ECHCG), Setaria viridis (SETVI), Abutilon theophrasti (ABUTH), Amaranthus retroflexus (AMARE), Apera spica-venti (APESV), Setaria faberi (SETFA), and mixtures thereof, preferably selected from the group consisting of Amaranthus retroflexus (AMARE), Echinochloa crus-galli (ECHCG), Apera spica-venti (APESV), and mixtures thereof or consisting of Amaranthus retroflexus (AMARE), Setaria viridis (SETVI), Abutilon theophrasti (ABUTH), Setaria faberi (SETFA), and mixtures thereof.

In a preferred embodiment, the substituent of the compound of formula (Ib) is further specified as follows:
R¹ is hydrogen, (C₁-C₈)-alkyl or (C₁-C₈)-haloalkyl, preferably hydrogen, (C₁-C₆)-alkyl, or (C₁-C₆)-haloalkyl, more preferably hydrogen, (C₂-C₄)-alkyl, or (C₂-C₄)-haloalkyl, even more preferably hydrogen, ethyl, or butyl, and in particular hydrogen or butyl, and the unwanted vegetation is selected from the group consisting of Amaranthus retroflexus (AMARE), Echinochloa crus-galli (ECHCG), Apera spica-venti (APESV), and mixtures thereof.

In a preferred embodiment, the substituent of the compound of formula (I) is further specified as follows:
R¹ is hydrogen or (C₁-C₈)-alkyl, preferably hydrogen or (C₂-C₄)-alkyl, even more preferably hydrogen, ethyl, or butyl, and in particular hydrogen or butyl and the unwanted vegetation is selected from the group consisting of Alopecurus myosuroides (ALOMY), Abutilon theophrasti (ABUTH), Apera spica-venti (APESV), Setaria viridis (SETVI), Amaranthus retroflexus (AMARE), Echinochloa crus-galli (ECHCG), and mixtures thereof.

In a preferred embodiment, the substituent of the compound of formula (Ia) is further specified as follows:
R¹ is hydrogen and the unwanted vegetation is selected from the group consisting of Alopecurus myosuroides (ALOMY), Abutilon theophrasti (ABUTH), and mixtures thereof.

In a preferred embodiment, the substituent of the compound of formula (Ib) is further specified as follows:
R¹ is hydrogen and the unwanted vegetation is selected from the group consisting of Echinochloa crus-galli (ECHCG), Setaria viridis (SETVI), Apera spica-venti (APESV), and mixtures thereof, preferably Apera spica-venti (APESV).

In a preferred embodiment, the substituent of the compound of formula (Ib) is further specified as follows:
R¹ is butyl and the unwanted vegetation is selected from the group consisting of Amaranthus retroflexus (AMARE), Echinochloa crus-galli (ECHCG), Setaria viridis (SETVI), Apera spica-venti (APESV), and mixtures thereof, preferably Amaranthus retroflexus (AMARE), Echinochloa crus-galli (ECHCG), and mixtures thereof.

In a preferred embodiment, the substituents of the compound of formula (II) are further specified as follows:
R¹ is hydrogen;
R² is hydrogen or methyl; and
R³ is hydrogen or methyl, and the unwanted vegetation is selected from the group consisting of Amaranthus retroflexus (AMARE), Setaria viridis (SETVI), Abutilon theophrasti (ABUTH), Setaria faberi (SETFA), and mixtures thereof.

In a preferred embodiment, the substituents of the compound of formula (II) are further specified as follows:
R¹ is hydrogen;
R² is hydrogen; and
R³ is hydrogen, and the unwanted vegetation is selected from the group consisting of Amaranthus retroflexus (AMARE), Echinochloa crus-galli (ECHCG), Setaria viridis (SETVI), Abutilon theophrasti (ABUTH), Setaria faberi (SETFA), and mixtures thereof, preferably selected from the group consisting of Setaria viridis (SETVI), Setaria faberi (SETFA), and mixtures thereof, and in particular Setaria viridis (SETVI). In this connection the compound of formula (II) is preferably in racemic form.

In a preferred embodiment, the substituents of the compound of formula (IIa) are further specified as follows:
R¹ is hydrogen;
R² is hydrogen; and
R³ is hydrogen, and the unwanted vegetation is Setaria viridis (SETVI).

In a preferred embodiment, the substituents of the compound of formula (IIb) are further specified as follows:
R¹ is hydrogen;
R² is hydrogen; and
R³ is hydrogen, and the unwanted vegetation is selected from the group consisting of Setaria viridis (SETVI), Abutilon theophrasti (ABUTH), Setaria faberi (SETFA), and mixtures thereof, preferably selected from the group consisting of Setaria viridis (SETVI), Setaria faberi (SETFA), and mixtures thereof, and in particular Setaria faberi (SETFA).

As mentioned above, the present invention further relates to a method for controlling unwanted vegetation which comprises allowing a herbicidally effective amount of at least one compound of formula (II)

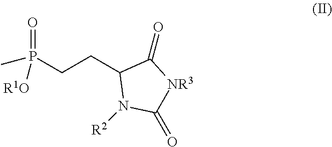

wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl;
R² is hydrogen, (C₁-C₃)-alkyl, or (C₁-C₃)-haloalkyl; and
R³ is hydrogen, (C₁-C₃)-alkyl, or (C₁-C₃)-haloalkyl;
including its agriculturally acceptable salts,
or a compound of formula (I) (first aspect), or the above-outlined composition (second aspect) to act on plants, their seed and/or their habitat.

Preferred embodiment, regarding the compound of formula (I), the compound of formula (II) and the composition are already above-outlined and apply for the method, as well.

Methods for applying compounds of formula (I), compounds of formula (II), and/or compositions comprising the same, on to plant propagation material, especially seeds, include dressing, coating, pelleting, dusting, soaking and in-furrow application methods of the propagation material. Preferably, compounds of formulae (I) and/or (II), and/or compositions comprising the same, respectively, are applied on to the plant propagation material by a method such that germination is not induced, e. g. by seed dressing, pelleting, coating and dusting.

Various types of oils, wetting agents, adjuvants, fertilizer, or micronutrients, and further pesticides (e.g. herbicides, insecticides, fungicides, growth regulators, safeners) may be added to the compounds of formulae (I) and/or (II), and/or the compositions comprising the same as premix or, if appropriate not until immediately prior to use (tank mix). These agents can be admixed with the composition according to the invention in a weight ratio of 1:100 to 100:1, preferably 1:10 to 10:1.

The user applies the compounds of formulae (I) and/or (II), and/or the compositions comprising the same usually from a pre-dosage device, a knapsack sprayer, a spray tank, a spray plane, or an irrigation system. Usually, the composition is made up with water, buffer, and/or further auxiliaries to the desired application concentration and the ready-to-use spray liquor or the composition according to the invention is thus obtained. Usually, 20 to 2000 liters, preferably 50 to 400 liters, of the ready-to-use spray liquor are applied per hectare of agricultural useful area.

According to one embodiment, either individual components of the composition according to the invention or partially premixed components, e. g. components comprising compounds of formulae (I) and/or (II) may be mixed by the user in a spray tank and further auxiliaries and additives may be added, if appropriate.

In a further embodiment, individual components of the composition according to the invention such as parts of a kit or parts of a binary or ternary mixture may be mixed by the user himself in a spray tank and further auxiliaries may be added, if appropriate.

In a further embodiment, either individual components of the composition according to the invention or partially premixed components, e. g components comprising compounds of formulae (I) and/or (II) and optionally further herbicides, can be applied jointly (e.g. after tank mix) or consecutively.

The compounds of formulae (I) and/or (II), and/or the compositions comprising the same, control undesired vegetation on non-crop areas efficiently, especially at high rates of application. They act against broad-leaved weeds and grass weeds in crops such as wheat, rice, maize, soya and cotton without causing any significant damage to the crop plants.

The compounds of formulae (I) and/or (II), and/or the compositions comprising the same, are applied to the plants mainly by spraying the leaves. Here, the application can be carried out using, for example, water as carrier by customary spraying techniques using spray liquor amounts of from about 100 to 1000 l/ha (for example from 300 to 400 l/ha). The compounds of formulae (I) and/or (II), and/or the compositions comprising the same, may also be applied by the low-volume or the ultra-low-volume method, or in the form of microgranules.

Application of the compounds of formulae (I) and/or (II), and/or the compositions comprising the same, can be done before, during and/or after, preferably during and/or after, the emergence of the undesired vegetation.

Application of the formulae (I) and/or (II), and/or the compositions comprising the same can be carried out before or during sowing.

The compounds of formulae (I) and/or (II), and/or the compositions comprising the same, can be applied pre-, post-emergence or pre-plant, or together with the seed of a crop plant. It is also possible to apply the compounds of formulae (I) and/or (II), and/or the compositions comprising the same, by applying seed, pretreated with the compounds of formulae (I) and/or (II), and/or the compositions comprising the same, of a crop plant. If the active ingredients are less well tolerated by certain crop plants, application techniques may be used in which the combinations are sprayed, with the aid of the spraying equipment, in such a way that as far as possible they do not come into contact with the leaves of the sensitive crop plants, while the active ingredients reach the leaves of undesired vegetation growing underneath, or the bare soil surface (post-directed, lay-by).

In a further embodiment, the compounds of formulae (I) and/or (II), and/or the compositions comprising the same, can be applied by treating seed. The treatment of seeds comprises essentially all procedures familiar to the person skilled in the art (seed dressing, seed coating, seed dusting, seed soaking, seed film coating, seed multilayer coating, seed encrusting, seed dripping and seed pelleting) based on the compounds of formulae (I) and/or (II), and/or the compositions comprising the same. Here, the combinations can be applied diluted or undiluted.

The term “seed” comprises seed of all types, such as, for example, corns, seeds, fruits, tubers, seedlings and similar forms. Here, preferably, the term seed describes corns and seeds. The seed used can be seed of the crop plants mentioned above, but also the seed of transgenic plants or plants obtained by customary breeding methods.

When employed in plant protection, the amounts of active substances applied, i.e. the compounds of formulae (I) and/or (II), are, depending on the kind of effect desired, from 0.001 to 10 kg per ha, preferably from 0.05 to 7 kg per ha, more preferably from 0. 5 to 6 kg per ha and in particular from 1 to 5 kg per ha.

In case of combinations according to the present invention it is immaterial whether the compounds of formulae (I) and/or (II) are formulated and applied jointly or separately.

In the case of separate application, it is of minor importance, in which order the application takes place. It is only necessary, that the compounds of formulae (I) and (II) are applied in a time frame that allows simultaneous action of the active ingredients on the plants, preferably within a time-frame of at most 14 days, in particular at most 7 days.

Depending on the application method in question, the compounds of formulae (I) and/or (II), and/or the compositions comprising the same, can additionally be employed in a further number of crop plants for eliminating undesired vegetation. Examples of suitable crops are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and Prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera and Zea mays.

Preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays.

Especially preferred crops are crops of cereals, corn, soybeans, rice, oilseed rape, cotton, potatoes, peanuts or permanent crops.

The compounds of formulae (I) and/or (II), and/or the compositions comprising the same, can also be used in crops which have been modified by mutagenesis or genetic engineering in order to provide a new trait to a plant or to modify an already present trait.

The term “crops” as used herein includes also (crop) plants which have been modified by mutagenesis or genetic engineering in order to provide a new trait to a plant or to modify an already present trait.

Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect.

In a preferred embodiment, the unwanted vegetation is selected from the group consisting of Alopecurus myosuroides (ALOMY), Avena fatua (AVEFA), Echinochloa crus-galli (ECHCG), Setaria viridis (SETVI), Abutilon theophrasti (ABUTH), Amaranthus retroflexus (AMARE), Apera spica-venti (APESV), Setaria faberi (SETFA), and mixtures thereof.

As mentioned above, the present invention further relates to a method of manufacturing glufosinate, its alkyl ester or the salts thereof having the formula (III)

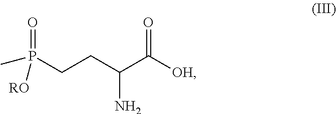

wherein R is hydrogen, (C₁-C₈)-alkyl, (C₁-C₈)-haloalkyl, (C₂-C₈)-alkenyl, (C₂-C₈)-haloalkenyl, or (C₂-C₈)-alkynyl, comprising the step of chemically cleaving off the carbamoyl moiety of a compound of formula (I)

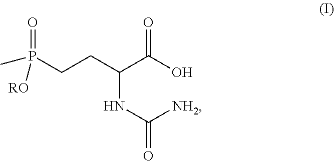

wherein R is hydrogen, (C₁-C₈)-alkyl, (C₁-C₈)-haloalkyl, (C₂-C₈)-alkenyl, (C₂-C₈)-haloalkenyl, or (C₂-C₈)-alkynyl.

It is to be understood that the compounds of formulae (I) and (III) encompass the respective agriculturally acceptable salts, amides, esters or thioesters and all possible stereoisomers.

Preferably, R of formulae (I) and (III) is hydrogen, (C₁-C₈)-alkyl, or (C₁-C₈)-haloalkyl, more preferably hydrogen, (C₁-C₆)-alkyl, or (C₁-C₆)-haloalkyl, even more preferably hydrogen, (C₂-C₄)-alkyl, or (C₂-C₄)-haloalkyl, still more preferably hydrogen, ethyl, or butyl, and in particular hydrogen.

It is to be understood that the compound of formula (I) may also be referred to as N-carbamoyl amino acid having the formula (I).

It is to be understood that the term “chemically cleaving” refers to a cleaving step that is not performed under enzymatic conditions. Any suitable chemical approach is possible.

Preferably, the chemically cleaving is performed under acidic conditions, preferably using hydrogen chloride, sulfuric acid, and mixtures thereof, more preferably hydrogen chloride, and in particular concentrated hydrogen chloride (i.e. 34 to 38% of hydrogen chloride in water).

Preferably, the chemically cleaving is performed by adding sodium nitrite.

Preferably, the chemically cleaving is performed at elevated temperature, more preferably at a temperature of 50 to 130° C., even more preferably of 70 to 120° C., and in particular of 80 to 110° C.

Preferably, the reaction pressure is ambient pressure. The reaction pressure is preferably in the range of 0.995 to 1.030 mbar, more preferably of 1.005 to 1.020 mbar, and in particular of about 1.013 mbar.

In a preferred embodiment of the present invention, the cleaving is performed at a pH of 0 to 5, preferably of 0 to 3.

In a particular embodiment, the chemically cleaving is performed by i) dissolving the N-carbamoyl amino acid having the formula (I) under acidic conditions, preferably at a temperature of −15 to 20° C., more preferably of −10 to 10° C., and in particular of −5 to 5° C., ii) addition of sodium nitrite, preferably following by stirring at a temperature of 10 to 35° C., preferably of 15 to 30° C., and in particular of 20 to 25° C. or room temperature, and optionally iii) heating the reaction mixture under acidic conditions to a temperature of 50 to 130° C., preferably of 70 to 120° C., and in particular of 80 to 110° C. Step iii) is suitable to cleave off the ester, if present.

The reaction mixture can be worked-up under standard procedure (i.e. washing and purifying).

The present invention is further illustrated by the following examples.

### EXAMPLES

### Material & Methods

### Cloning of Enzyme Genes

The amino acid sequence of the respective enzyme was identified from public databases (UniProt, https://www.uniprot.org). The respective DNA sequence was derived thereof using standard codon usage of Escherichia coli. The DNA sequence was synthesized (BioCat GmbH) and cloned into the plasmid pDHE19.2 (Ress-Loeschke, M. et al., DE 19848129, 1998, (BASF AG)). The resulting plasmids were used to transform competent cells (Chung, C. T. et al., Proc Natl Acad Sci USA, 1989, 86, 2172) of the E. coli strain TG10, pAgro, pHSG575 (E. coli TG10 (Kesseler, M. et al., WO2004050877A1, 2004, (BASF AG)):rhaA-derivate of E. coli TG1 transformed with pHSG575 (Takeshita, S. et al., Gene, 1987, 61, 63) and pAgro4 (pBB541 in Tomoyasu, T. et al., Mol. Microbiol., 2001, 40, 397).

### Recombinant Production of Enzymes

E. coli TG10 carrying the recombinant plasmid of the enzyme was used to inoculate 2 ml LB medium (Bertani, G., J Bacteriol, 1951, 62, 293) supplemented with 100 μg/l ampicillin, 100 μg/l spectinomycin, 20 μg/l chloramphenicol and the resulting pre-culture was incubated for 5 h at 37° C. at an agitation of 250 rpm. 1 ml of the pre-culture was used to inoculate 100 ml LB medium supplemented with 100 μg/l ampicillin, 100 μg/l spectinomycin, 20 μg/l chloramphenicol, 1 mM MnCl2, 0.1 mM isopropyl-β-D-thiogalactopyranosid, and 0.5 g/l rhamnose in a 500 ml baffled Erlenmeyer-flask. The culture was incubated at 37° C. for 18 h under shaking conditions. Subsequently, the biomass was harvested by centrifugation at 3220×g for 10 min at 8° C. The supernatant was discarded, and the cell pellet resuspended in 8 ml HEPES buffer at a concentration of 100 mM and pH 8.2 supplemented with 1 mM MnCl2. The cell suspension was used without any further preparation for synthesis in case whole cell biotransformation were carried out. In case cleared cell lysates were employed instead, 5 ml of the cell suspension were distributed into 5 reaction tubes containing lysing matrix B (0.7 ml quartz-beads at Ø0.1 mm, MP Biomedicals), the tubes chilled on ice, and cells subsequently broken in a homogenizer (Peqlab Precellys24, VWR) for two 30 second cycles. In between cycles samples were chilled on ice. The resulting cell free lysates were cleared by centrifugation 20817×g for 10 min, at 8° C. The supernatants were isolated and fractions from the same batch combined (=cleared cell lysate).

### Synthesis of N-Carbamoyl Amino acid and Hydantoins

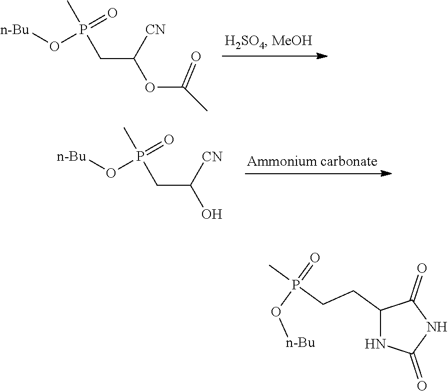

To a stirred solution of [2-[butoxy(methyl)phosphoryl]-1-cyano-ethyl]acetate (100 g, purity 90%, Cas 167004-78-6) in methanol (400 mL) was added concentrated sulfuric acid (1 g) and the reaction mixture was heated to 40° C. and stirred for 15 h at this temperature. The reaction mixture was allowed to cool to room temperature, then sodium methoxide in methanol (30%, 3.52 g) was added, followed by sodium sulfate (2 g) and stirred at room temperature for 30 min. The reaction mixture was filtered and the filtrate concentrated under reduced pressure (84.5 g).

To the crude butyl 3-cyano-3-hydroxypropyl(methyl)phosphinate (84.5 g, 366 mmol) was added a solution of diammonium carbonate (70.4 g, 732 mmol) in water (290 mL). The reaction mixture was heated to 70° C. for 4 h and then evaporated to dryness under reduced pressure. The residue was suspended in warm isopropanol (70° C.), the resulting suspension was filtered and the filter cake washed with isopropanol (2×10 mL). The filtrate was concentrated under reduced pressure and filtered through silica (elution with 1.5 L dichloromethane/methanol 9:1). The filtrate was concentrated under reduced pressure to yield 55.5 g of product and the resulting solid was recrystallized form isopropanol/diisopropylether (Compound g, yield 34%). ¹H NMR (500 MHz, Deuterium Oxide) δ 4.42-4.37 (m, 1H), 4.08-4.00 (m, 2H), 2.19-1.77 (m, 4H), 1.70-1.64 (m, 2H), 1.61 (d, J=13.8 Hz, 3H), 1.46-1.34 (m, 2H), 0.92 (td, J=7.4, 0.8 Hz, 3H).

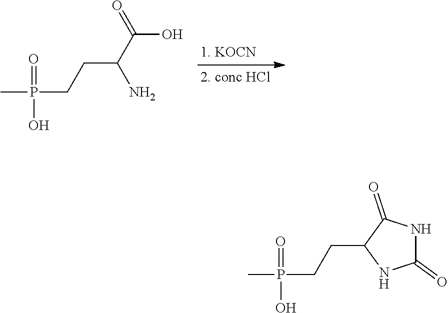

To a stirred solution of glufosinate ammonium (50% in water, 50 g, 126 mmol) under vacuum (200 m bar) was added a solution of potassium cyanate (17 g, 202 mmol) in water (50 ml) at 50° C. over a period of 40 min. The reaction mixture was stirred at 50° C. under vacuum (200 mbar) for an additional 1.5 h and then allowed to cool to room temperature. After stirring at room temperature and ambient pressure for an additional 14 h, concentrated HCL (125 mL, 36%) was added and the reaction mixture was heated to reflux for 30 min. The reaction mixture was concentrated under reduced pressure. The residue was dissolved in water at 50° C. (50 mL) and filtered. The filtrate was subjected to ion exchange chromatography (Dowex-50 WX 8 200-400 (H), 500 mL) and the product eluted with water (1 L). The eluted product was concentrated under reduced pressure yielding an amourphous solid which was recrystallized from ethanol to obtain Compound c. ¹H NMR (500 MHz, Deuterium Oxide) δ 4.41-4.36 (m, 1H), 2.15-1.70 (m, 4H), 1.52 (d, J=13.9 Hz, 3H). The D- and L-enantiomers (compounds d and e) were synthesized starting from commercially available D- and L-Glufosinate in an analogous fashion. Specific rotation for compoundd[α]=+58.8° (c=1H₂O) and compounde[α]=−49.1° (c=1H₂O).

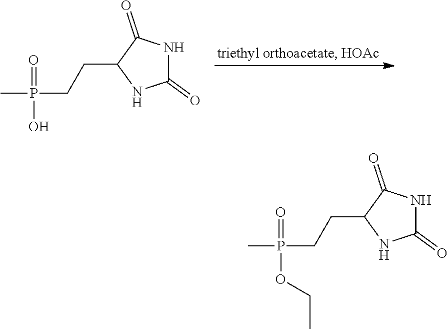

To a mixture of acetic acid (50 mL) and triethyl orthoacetate (75 mL, 409 mmol) was added ethyl 2-(2,5-dioxoimidazolidin-4-yl)ethyl(methyl)phosphinate (10 g, 48.5 mmol) at room temperature. The reaction mixture was heated to reflux (110° C., heating bath temperature) for 15 min. The reaction was then concentrated under reduced pressure and purified by column chromatography (dichloromethane/methanol 9:1) yielding ethyl 2-(2,5-dioxoimidazolidin-4-yl)ethyl(methyl)phosphinate (4.8 g, 42%).

¹H NMR (500 MHz, Deuterium Oxide) δ 4.41-4.36 (m, 1H), 4.13-4.03 (m, 2H), 2.19-1.74 (m, 4H), 1.60 (d, J=13.9 Hz, 3H), 1.35-1.28 (m, 3H).

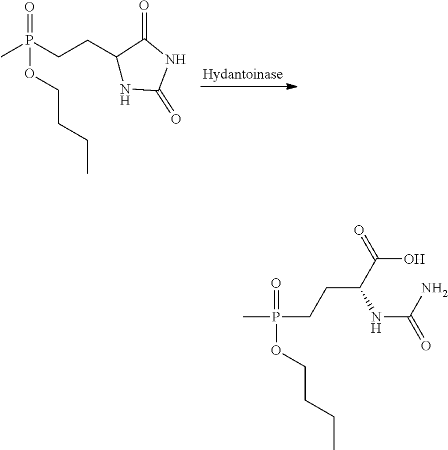 [SMILES: CCCCOP(C)(=O)CCC1NC(=O)NC1=O ; CCCCOP(C)(=O)CC[C@@H](NC(N)=O)C(=O)O]

To a solution of ([2-[butoxy(methyl)phosphoryl]ethyl]imidazolidine-2,4-dione (1.65 g, 6.3 mmol) in degassed aqueous potassium phosphate buffer (12.6 mL, 0.5 M, pH 8.0) was added KOH (3M in Water, 150 μL) to adjust the pH to 8.0. To the mixture was added potassium phosphate buffer (47.2 mL, 0.100 M, pH 8.0) and Hydantoinase enzyme (Uniprot Q45515, Seq ID 1: cleared cell lysate, 3.1 mL, 22.1 mg/mL total protein concentration). The reaction mixture was stirred (250 rpm) at 37° C. for 24 h. NMR showed 36% conversion to the carbamoylic acid. The crude material was filtered to remove the cell lysate and the filter cake washed with water (20 mL). The filtrate was concentrated under reduced pressure, redissolved in THF/wet MeOH and purified by a normal phase chromatography (gradient 1:1 dichloromethane:methanol to pure methanol). The D-enantiomer (compound f) which was obtained has a specific rotation [α]=−20.7° (c=1H₂O).

1H NMR (500 MHz, Deuterium Oxide) δ 4.11-4.07 (m, 1H), 4.06-4.00 (m, 2H), 2.09-1.80 (m, 4H), 1.71-1.63 (m, 2H), 1.59 (d, J=13.7 Hz, 3H), 1.46-1.34 (m, 2H), 0.92 (t, J=7.4 Hz, 3H). In order to obtain the ee of compound f it was degraded to glufosinate:

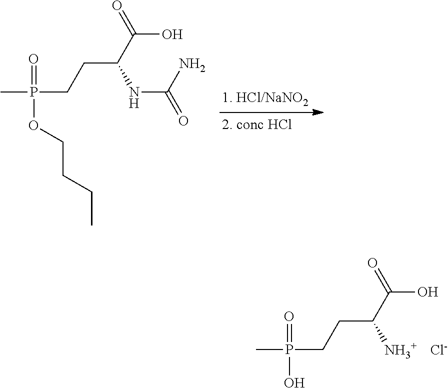 [SMILES: CCCCOP(C)(=O)CC[C@@H](NC(N)=O)C(=O)O ; CP(=O)(O)CC[C@@H]([NH3+])C(=O)O ; [Cl-]]

4-[butoxy(methyl)phosphoryl]-2-ureido-butanoic acid (300 mg), synthesized using a Hydantoinase (Uniprot: Q45515), was dissolved in aqueous HCl (3.5 M, 30 mL) and the stirred reaction mixture was cooled to 0° C. A solution of sodium nitrite (77 mg) in water (3 mL) was added and the reaction mixture was allowed to warm to room temperature. The reaction mixture was stirred at room temperature for an additional 2 hours. Then conc. HCl in water (36%, 7.5 mL) was added and the reaction mixture was heated to 100° C. and stirred at this temperature overnight. The reaction mixture was cooled to room temperature and extracted twice with methylene chloride (2×10 mL). The aqueous phase was concentrated under reduced pressure to obtain the hydrochloric acid salt of glufosinate and subjected to chiral HPLC analytics. 1H NMR (500 MHz, Deuterium Oxide) δ 3.84-3.78 (m, 1H), 2.17-2.00 (m, 2H), 1.74-1.54 (m, 2H), 1.27 (d, J=13.5 Hz, 3H). Chiral HPLC: 97%-D-Glufosinate/3% L-Glufosinate; Analytical Method: Chirex (D)-Pencillamine 250×4.6 mm column from Phenomenex; isocratic elution 10 mM Copper (II) sulfate; UV detection at 245 nm).

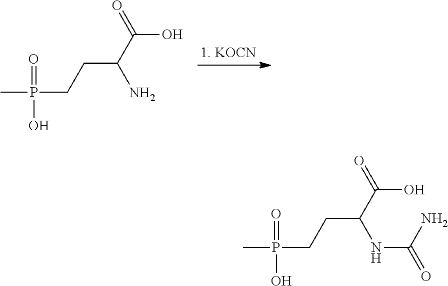

To a stirred solution of glufosinate ammonium (50% in water, 39.6 g, 99.9 mmol) under vacuum (200 m bar) was added a solution of potassium cyanate (11.8 g, 145 mmol) in water (30 ml) at 50° C. over a period of 30 min. The reaction mixture was stirred at 50° C. under vacuum (200 mbar) for an additional 1 h and then allowed to cool to room temperature. The reaction mixture was subjected to ion exchange chromatography (Dowex-50 WX 8 200-400 (H), 220 mL) and the product eluted with water (1 L). The eluted product was concentrated under reduced pressure yielding the carbamoylic acid product (7.9 g). The remaining carbamoylic acid was isolated from the column as the potassium salt. 1H NMR (500 MHz, Deuterium Oxide) δ 4.31-4.25 (m, 1H), 2.19-1.81 (m, 4H), 1.52 (d, J=14.1 Hz, 3H). The L-enantiomer (compound a) and D-enantiomer (compound b) were synthesized starting from commercially available L- and D-Glufosinate in an analogous fashion. Specific rotation for compound a [α]=+27.5° (c=1H₂O, Potassium salt).

### Herbicidal Tests

The herbicidal activity of the compounds of formulae (I) and (II) was demonstrated by the following greenhouse experiments:

The culture containers used were plastic flowerpots containing loamy sand with approximately 3.0% of humus as the substrate. The seeds of the test plants were sown separately for each species.

For the pre-emergence treatment, the active ingredients, which had been suspended or emulsified in water, were applied directly after sowing by means of finely distributing nozzles. The containers were irrigated gently to promote germination and growth and subsequently covered with transparent plastic hoods until the test plants had rooted. This cover caused uniform germination of the test plants, unless this had been impaired by the active ingredients.

For the post-emergence treatment, the test plants were first grown to a height of 2 to 15 cm, depending on the plant habit, and only then treated with the active ingredients which had been suspended or emulsified in water. For this purpose, the test plants were either sown directly and grown in the same containers, or they were first grown separately as seedlings and transplanted into the test containers a few days prior to treatment.

Depending on the species, the test plants were kept at 10-25° C. or 20-35° C., respectively.

The test period extended over 2 to 4 weeks. During this time, the test plants were tended, and their response to the individual treatments was evaluated.

Evaluation was carried out using a scale from 0 to 100. 100 means no emergence of the test plants, or complete destruction of at least the aerial moieties, and 0 means no damage, or normal course of growth. A moderate herbicidal activity is given at values of 40 to 59, good herbicidal activity is given at values of more than 59 to 80 and a very good herbicidal activity is given at values of more than 80 to 100.

The test plants used in the greenhouse experiments were of the following species:

| Bayer code | Scientific name |
|---|---|
| ALOMY | Alopercurus myosuroides |
| AVEFA | Avena fatua |
| ECHCG | Echinocloa crus-galli |
| SETVI | Setaria viridis |
| ABUTH | Abutilon theophrasti |
| AMARE | Amaranthus retroflexus |
| APESV | Apera spica-venti |
| SETFA | Setaria faberi |

### Testes Compounds

| | |
|---|---|
| Compound a | L-N-carbamoyl amino acid |
| Compound b | D-N-carbamoyl amino acid |
| Compound c | Hydantoin rac. |
| Compound d | D-Hydantoin |
| Compound e | L-Hydantoin |
| Compound f | D-N-carbamoyl amino acid |
| Compound g | Hydantoin rac. |

At an application rate of 5 kg/ha, applied by the pre-emergence method or the postemergence method:
Compound c shows very good herbicidal activity against SETVI (postemergence)
Compound b shows good herbicidal activity against APESV (pre-emergence)
Compounds c and d show good herbicidal activity against SETFA (pre-emergence)
Compound e shows a good herbicidal activity against SETVI (postemergence)
Compound f shows a good herbicidal activity against AMARE and ECHCG (postemergence)
Compound a shows a moderate herbicidal activity against ALOMY (postemergence)
Compounds a, c, and d show a moderate herbicidal activity against ABUTH (pre-emergence)
Compounds b and c show a moderate herbicidal activity against ECHCG (postemergence)
Compounds b, d, f, and g show a moderate herbicidal activity against SETVI (postemergence)
Compound c shows a moderate herbicidal activity against AMARE (postemergence)
Compounds f and g show a moderate herbicidal activity against APESV (pre-emergence)

SEQ ID NO: 1
MTKLIKNGTIVTATDIYEADLLIQDGKIAVIGRNLDESGAEVIDATGCY
VFPGGIDPHTHLDMPFGGTVTKDDFESGTIAAAFGGTTTIIDFCLTNKG
EPLKKAIETWHNKATGKAVIDYGFHLMISEITDDVLEELPKVIEEEGIT
SFKVFMAYKDVFQADDGTLYRTLVAAKELGALVMVHAENGDVIDYLTKK
ALEDGHTDPIYHALTRPPELEGEATGRACQLTELAGSQLYVVHVSCAQA
VEKIAEARNKGLNVWGETCPQYLVLDQSYLEKPNFEGAKYVWSPPLREK
WHQEVLWNALKNGQLQTLGSDQCSFDFKGQKELGRGDFTKIPNGGPIIE
DRVSILFSEGVKKGRITLNQFVDIVSTRIAKLFGLFPKKGTIAVGADAD
LVIFDPTVERVISAETHHMAVDYNPFEGMKVTGEPVSVLCRGEFVVRDK
QFVGKPGYGQYVKRAKYGALMADQDVVKMS

1. A compound of formula (I) 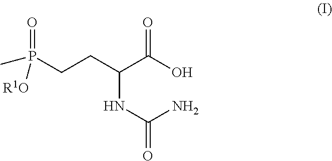
wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl;
including its agriculturally acceptable salts, amides, esters or thioesters.

2. The compound according to claim 1, wherein
R¹ is hydrogen, (C₁-C₈)-alkyl, or (C₁-C₈)-haloalkyl.

3. The compound according to claim 1, wherein formula (I) is the stereoisomer having formula (Ia) 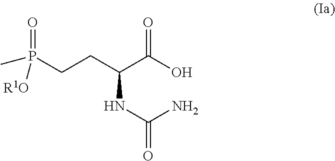
or having formula (Ib)

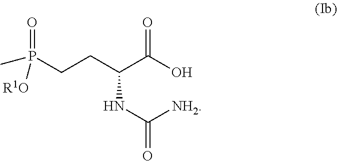

4. A composition comprising at least one compound according to claim 1 and at least one auxiliary, which is customary for formulating crop protection compounds.

5. The composition according to claim 4, comprising a compound having formula (II) 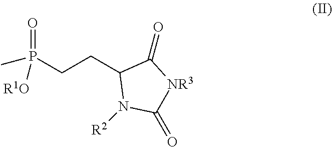
wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl;
R² is hydrogen, (C₁-C₃)-alkyl, or (C₁-C₃)-haloalkyl; and
R³ is hydrogen, (C₁-C₃)-alkyl, or (C₁-C₃)-haloalkyl;
including its agriculturally acceptable salts.

6. The composition according to claim 4, comprising a further herbicide.

7. Use of a compound of formula (II) 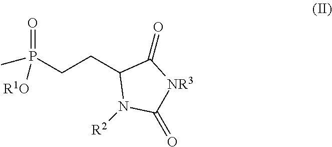
wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl;
R² is hydrogen, (C₁-C₃)-alkyl, or (C₁-C₃)-haloalkyl; and
R³ is hydrogen, (C₁-C₃)-alkyl, or (C₁-C₃)-haloalkyl;
including its agriculturally acceptable salts, for controlling unwanted vegetation.

8. The use according to claim 7, wherein the substituents of the compound of formula (II) are further specified as follows:
R¹ is hydrogen, (C₁-C₆)-alkyl, or (C₁-C₆)-haloalkyl;
R² is hydrogen or (C₁-C₃)-alkyl; and
R³ is hydrogen or (C₁-C₃)-alkyl.

9. The use according to claim 7, wherein the formula (II) is the stereoisomer having formula (IIa) 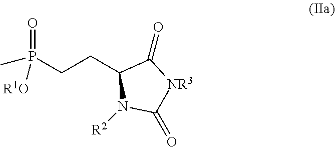
or formula (IIb)

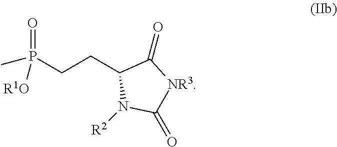

10. The use according to claim 7, wherein unwanted vegetation is selected from the group consisting of Alopecurus myosuroides (ALOMY), Avena fatua (AVEFA), Echinochloa crus-galli (ECHCG), Setaria viridis (SETVI), Abutilon theophrasti (ABUTH), Amaranthus retroflexus (AMARE), Apera spica-venti (APESV), Setaria faberi (SETFA), and mixtures thereof.

11. The use according to claim 7, wherein the substituent of the compound of formula (Ib) is further specified as follows:
R¹ is hydrogen, (C₁-C₈)-alkyl or (C₁-C₈)-haloalkyl, and the unwanted vegetation is selected from the group consisting of Amaranthus retroflexus (AMARE), Echinochloa crus-galli (ECHCG), Apera spica-venti (APESV), and mixtures thereof.

12. The use according to claim 7, wherein the substituents of the compound of formula (II) are further specified as follows:
R¹ is hydrogen;
R² is hydrogen or methyl; and
R³ is hydrogen or methyl, and the unwanted vegetation is selected from the group consisting of Amaranthus retroflexus (AMARE), Setaria viridis (SETVI), Abutilon theophrasti (ABUTH), Setaria faberi (SETFA), and mixtures thereof.

13. A method for controlling unwanted vegetation which comprises allowing a herbicidally effective amount of at least one compound of formula (II) 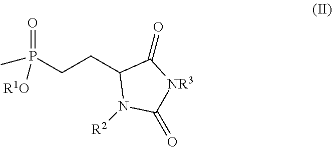
wherein
R¹ is hydrogen, (C₁-C₈)-alkyl, (C₁-C₈)-haloalkyl, (C₂-C₈)-alkenyl, (C₂-C₈)-haloalkenyl, or (C₂-C₈)-alkynyl;
R² is hydrogen, (C₁-C₃)-alkyl, or (C₁-C₃)-haloalkyl; and
R³ is hydrogen, (C₁-C₃)-alkyl, or (C₁-C₃)-haloalkyl;
including its agriculturally acceptable salts, to act on plants, their seed and/or their habitat.

14. The method according to claim 13, wherein the unwanted vegetation is selected from the group consisting of Alopecurus myosuroides (ALOMY), Avena fatua (AVEFA), Echinochloa crus-galli (ECHCG), Setaria viridis (SETVI), Abutilon theophrasti (ABUTH), Amaranthus retroflexus (AMARE), Apera spica-venti (APESV), Setaria faberi (SETFA), and mixtures thereof.

15. A method of manufacturing glufosinate, its alkyl ester or the salts thereof having the formula (III) 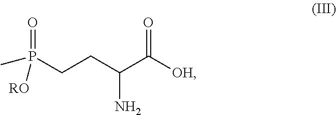
wherein R is hydrogen, (C₁-C₈)-alkyl, (C₁-C₈)-haloalkyl, (C₂-C₈)-alkenyl, (C₂-C₈)-haloalkenyl, or (C₂-C₈)-alkynyl, comprising the step of chemically cleaving off the carbamoyl moiety of a compound of formula (I) 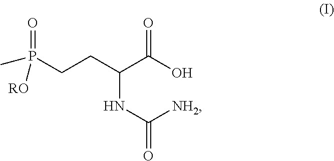
wherein R is hydrogen, (C₁-C₈)-alkyl, (C₁-C₈)-haloalkyl, (C₂-C₈)-alkenyl, (C₂-C₈)-haloalkenyl, or (C₂-C₈)-alkynyl.
